(19) United States
(12) Patent Application Publication
(10) Pub. No.: US 2023/0408741 A1
(43) Pub. Date: Dec. 21, 2023

(54) OPTICAL ANGULAR FILTER

(71) Applicant: ISORG, Limoges CEDEX 3 (FR)

(72) Inventors: Fabien GEOFFRAY, GRENOBLE (FR); Anthony BARBOT, GRENOBLE (FR)

(21) Appl. No.: 18/267,053

(22) PCT Filed: Dec. 13, 2021
(86) PCT No.: PCT/EP2021/085408

§ 371 Date: Jun. 13, 2023

(30) Foreign Application Priority Data
Dec. 15, 2020 (FR) 20/13270

(51) Int. Cl. G02B 5/20

(52) U.S. Cl. CPC G02B 5/201

(57) ABSTRACT

An optical angular filter includes a network of pillars made of a first transparent material, and an array of walls made of a second opaque material, separating the pillars from one another. The refraction index of the second material is different from that of the first material.

### RELATED APPLICATION

The present patent application claims the priority benefit of French patent application 20/13270, filed on Dec. 15, 2020, which is herein incorporated by reference as authorized by law.

### FIELD

The present disclosure concerns an optical filter, and more precisely an optical angular filter.

More particularly, the present disclosure concerns an angular filter intended to be used within an optical system, for example, a biometric imaging system.

### BACKGROUND

An angular filter is a device enabling to filter an incident radiation according to the incidence of this radiation and thus to block rays having an incidence greater than a maximum incidence. Angular filters are frequently used in association with image sensors.

### SUMMARY OF THE INVENTION

There is a need to improve known angular filters.

An embodiment overcomes all or part of the disadvantages of known optical angular filters.

An embodiment provides an optical angular filter comprising:
a network of pillars made of a first transparent material;
an array of walls made of a second opaque material, separating the pillars from one another,
the ratio between the refraction indexes of the first and second materials depending on the wavelength.

According to an embodiment, the difference between the refraction indexes of the first and second materials changes sign at a given wavelength.

According to an embodiment, the ratio between the refraction indexes of the materials inverts for a given wavelength.

According to an embodiment, the refraction index of the first material is, for wavelengths in the infrared range, greater than the refraction index of the second material and, for wavelengths in the visible range, smaller than the refraction index of the second material.

According to an embodiment, the refraction index of the second material is smaller than that of the first material, for at least a portion of the spectrum.

According to an embodiment, the refraction index difference between the two materials is in the range from entre 0.001 to 0.5.

According to an embodiment, the refraction index of the first material is, according to the wavelength, in the range from 1.55 to 1.65 and is, at a wavelength smaller than said given wavelength, in the order of 1.57, preferably 1.57.

According to an embodiment, the refraction index of the second material is, at a wavelength smaller than said given wavelength, in the range from 1.45 to 1.6.

According to an embodiment, the refraction index of the second material is in the range from 1.52 to 1.57 and is, at a wavelength smaller than said given wavelength, in the order of 1.55, preferably 1.55.

According to an embodiment, the refraction index of the second material is in the range from 1.45 to 1.5 and is, at a wavelength smaller than said given wavelength, in the order of 1.49, preferably 1.49.

According to an embodiment, the thickness of the filter is selected according to the selectivity desired for the angular filter.

According to an embodiment, the first and second materials are organic resins.

According to an embodiment, the angular filter further comprises an array of microlenses.

An embodiment provides an image acquisition device comprising an angular filter.

### BRIEF DESCRIPTION OF THE DRAWINGS

The foregoing features and advantages, as well as others, will be described in detail in the rest of the disclosure of specific embodiments given by way of illustration and not limitation with reference to the accompanying drawings, in which:

FIG. 1 shows, in a partial and simplified block diagram, an embodiment of an image acquisition system;

FIG. 2 shows, in a partial and simplified cross-section view, an embodiment of an image acquisition device comprising an angular filter;

FIG. 3 illustrates in a simplified cross-section view, the operation of an embodiment of an angular filter;

FIG. 4 illustrates in another simplified cross-section view, the operation of an embodiment of an angular filter;

FIG. 5 illustrates in still another simplified cross-section view, the operation of an embodiment of an angular filter;

FIG. 6 shows examples of transmittance of angular filters; and

FIG. 7 illustrates the operation of a preferred embodiment of an angular filter.

### DESCRIPTION OF THE EMBODIMENTS

Like features have been designated by like references in the various figures. In particular, the structural and/or functional features that are common among the various embodiments may have the same references and may dispose identical structural, dimensional and material properties.

For the sake of clarity, only the steps and elements that are useful for an understanding of the embodiments described herein have been illustrated and described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, when reference is made to terms qualifying absolute positions, such as terms “front”, “rear”, “top”, “bottom”, “left”, “right”, etc., or relative positions, such as terms “above”, “under”, “upper”, “lower”, etc., or to terms qualifying directions, such as terms “horizontal”, “vertical”, etc., it is referred to the orientation of the drawings or to a . . . in a normal position of use.

Unless specified otherwise, the expressions “around”, “approximately”, “substantially” and “in the order of” signify within 10%, and preferably within 5%.

Unless specified otherwise, the expressions “all the elements”, “each element”, signify between 95% and 100% of the elements. In the following description, unless specified otherwise, a layer or a film is called opaque to a radiation when the transmittance of the radiation through the layer or the film is smaller than 10%. In the rest of the disclosure, a layer or a film is called transparent to a radiation when the transmittance of the radiation through the layer or the film is greater than 10%, preferably greater than 50%. According to an embodiment, for a same optical system, all the elements of the optical system which are opaque to a radiation have a transmittance which is smaller than half, preferably smaller than one fifth, more preferably smaller than one tenth, of the lowest transmittance of the elements of the optical system transparent to said radiation. In the rest of the disclosure, there is called “useful radiation” the electromagnetic radiation crossing the optical system in operation. In the rest of the disclosure, there is called “micrometer-range optical element” an optical element formed on a surface of a support having a maximum dimension, measured parallel to said surface, greater than 1 μm and smaller than 1 mm.

Embodiments of optical systems will now be described for optical systems comprising an array of micrometer-range optical elements in the case where each micrometer-range optical element corresponds to a micrometer-range lens, or microlens, formed of two diopters. It should however be clear that these embodiments may also be implemented with other types of micrometer-range optical elements, where each micrometer-range optical element may for example correspond to a micrometer-range Fresnel lens, to a micrometer-range index gradient lens, or to a micrometer-range diffraction grating.

In the following description, there is called visible light an electromagnetic radiation having a wavelength in the range from 400 nm to 700 nm, and, in this range, green light an electromagnetic radiation having a wavelength in the range from, 400 nm to 600 nm, more preferably from 470 nm to 600 nm. There is called infrared radiation an electromagnetic radiation having a wavelength in the range from 700 nm to 1 mm. In infrared radiation, one can in particular distinguish near infrared radiation having a wavelength in the range from 700 nm to 1.7 μm, more preferably from 850 nm to 940 nm.

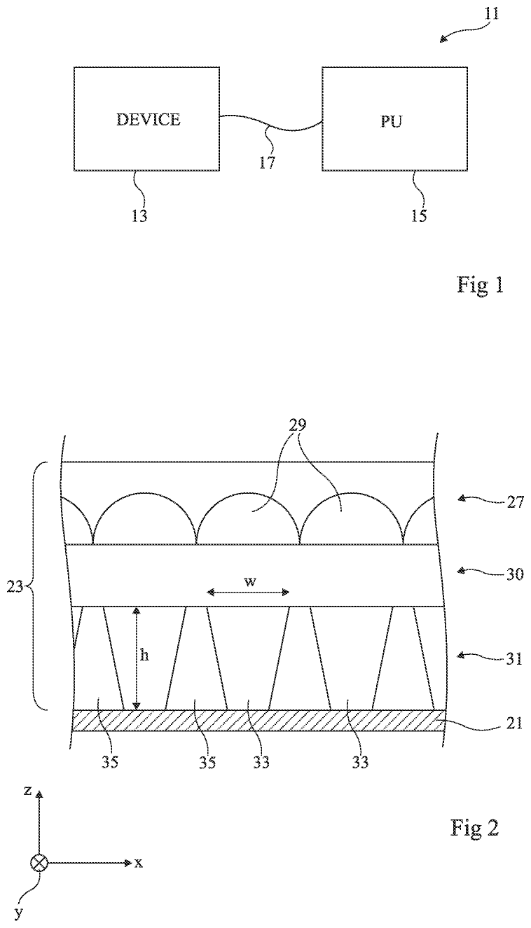

FIG. 1 illustrates, in a partial and simplified block diagram, an embodiment of an image acquisition system 11.

Image acquisition system 11, illustrated in FIG. 1, comprises:
an image acquisition device 13 (DEVICE); and
a processing unit 15 (PU).

Processing unit 15 preferably comprises means for processing the signals delivered by device 11, not shown in FIG. 1. Processing unit 15 for example comprises a microprocessor.

Device 13 and processing unit 15 are preferably coupled by a link 17. Device 13 and processing unit 15 are for example integrated in a same circuit.

FIG. 2 shows, in a partial simplified cross-section view, an embodiment of an image acquisition device 19 comprising an angular filter.

The image acquisition device 19 shown in FIG. 2 comprises, from bottom to top in the orientation of the drawing:
an image sensor 21; and
an angular filter 23, covering image sensor 21.

In the present disclosure, the embodiments of the devices of FIGS. 2 to 5 are shown in space according to a direct orthogonal coordinate system XYZ, the Z axis of coordinate system XYZ being orthogonal to the upper surface of image sensor 21.

Image sensor 21 comprises an array of photon sensors, also called photodetectors. The photodetectors are preferably arranged in array form. The photodetectors may be covered with a protective coating, not shown.

According to an embodiment, the photodetectors preferably all have the same structure and the same properties/characteristics. In other words, all photodetectors are substantially identical to within manufacturing tolerances.

As a variant, the photodetectors do not all have the same characteristics and be sensitive to different wavelengths. In other words, photodetectors may be sensitive to an infrared radiation and photodetectors may be sensitive to a radiation in the visible range.

Image sensor 21 further comprises conductive tracks and switching elements, particularly transistors, not shown, allowing the selection of the photodetectors.

The photodetectors are preferably made of organic materials. The photodiodes are for example organic photodiodes (OPD) integrated on a CMOS (Complementary Metal Oxide Semiconductor) substrate or a thin film transistor substrate (TFT). The substrate is for example made of silicon, preferably, of single-crystal silicon. The channel, source, and drain regions of the TFT transistors are for example made of amorphous silicon (a-Si), of indium gallium zinc oxide (IGZO), or of low temperature polysilicon (LIPS).

The photodiodes of image sensor 21 comprise, for example, a mixture of organic semiconductor polymers, for example poly(3-hexylthiophene) or poly(3-hexylthiophene-2,5-diyl), known as P3HT, mixed with [6,6]-phenyl-C61-butyric acid methyl ester (N-type semiconductor), known as PCBM.

The photodiodes of image sensor 21 for example comprise small molecules, that is, molecules having molar masses smaller than 500 g/mol, preferably, smaller than 200 g/mol.

The photodiodes may be non-organic photodiodes, for example, formed based on amorphous silicon or crystal silicon. As an example, the photodiodes are formed of quantum dots.

Angular filter 23 comprises, according to the described embodiments, an array 31 or layer of holes or openings 33 made of a first opaque material, filled with a second transparent material forming a network or an array of transparent pillars 33. In other words, the first material defines opaque walls 35 forming a grid around transparent pillars 33. In practice, the manufacturing of the angular filter is generally reverse, that is, it is started by forming a network of transparent pillars 33 and the interstices between pillars are filled with an opaque material forming a grid in each mesh of which is located a transparent pillar.

The transparency and the opacity of the materials forming the angular filter should be understood with respect to the radiation or radiations to which the image acquisition device applies.

In the example of FIG. 2, pillars 33 have, in the XZ plane, a decreasing cross-section towards sensor 21. In this case, walls 35 have, conversely, in the XZ plane, an increasing cross-section towards the sensor.

According to another embodiment, the pillars and walls have regular cross-sections across the thickness (Z dimension) of filter 23.

Generally, each pillar 33 (or opening 33 in the angular filter) may have a trapezoidal, rectangular shape or be funnel-shaped. Each pillar 33, in top view (that is, in the XY plane), may have a circular, oval, or polygonal shape, for example, triangular, square, rectangular, or trapezoidal. Each pillar 33, in top view, has a preferably circular shape. There is defined by width of a pillar 33 the characteristic dimension of pillar 33 in the XY plane. For example, for a pillar 33 having a square-shaped cross-section in the XY plane, the width corresponds to the dimension of a side and for a pillar 33 having a circular-shaped cross-section in the XY plane, the width corresponds to the diameter of pillar 33. Further, there is called center of a pillar 33 the point located at the intersection of the axis of symmetry of pillars 33 and of the lower surface of the level, array or layer, 31. For example, for circular pillars 33, the center of each pillar 33 is located on the axis of revolution of pillar 33.

The function of angular filter 23 is to control the rays received by the image sensor according to the incidence of these rays at the outer surface of the filter. An angular filter more particularly enables to only select the light of a scene to be imaged with an incidence close to the normal.

An angular filter is generally characterized by the width of the transmission peak at the half maximum (in degrees) of its transmittance. It is generally spoken of a half width at half maximum of the transmittance of the angular filter (HWHM: Half Width Half Maximum).

Preferably, the angular filter further comprises an array 27 of microlenses 29 of micrometer-range size, for example, plan-convex.

According to an embodiment, the array 27 of microlenses 29 is formed on a substrate or support 30 and in contact therewith, substrate 30 then being interposed between microlenses 29 and array 31.

Substrate 30 may be made of a transparent polymer which does not absorb, at least, the considered wavelengths, here in the visible and near infrared range. The polymer may in particular be polyethylene terephthalate PET, poly(methyl methacrylate) PMMA, cyclic olefin polymer (COP), polyimide (PI), polycarbonate (PC). The thickness of substrate 30 may vary between 1 μm and 100 μm, preferably between 10 μm and 100 μm. Substrate 30 may correspond to a colored filter, to a polarizer, to a half-wave plate or to a quarter-wave plate.

Lenses 29 may be made of silica, of PMMA, of positive resist, of PET, of poly(ethylene naphthalate) (PEN), of COP, of polydimethylsiloxane (PDMS)/silicone, of epoxy resin, or of acrylate resin. Microlenses 29 may be formed by creeping of resist blocks. Microlenses 29 may further be formed by imprinting on a layer of PET, PEN, COP, PDMS/silicone, of epoxy resin, or of acrylate resin. Microlenses 29 are converging lenses, each having a focal distance f in the range from 1 μm to 100 μm, preferably from 1 μm to 70 μm. According to an embodiment, all microlenses 29 are substantially identical.

When they are present in the angular filter, microlenses 29 and substrate 30 are preferably made of materials which are transparent or partially transparent, that is, transparent in a portion of the spectrum considered for the targeted field, for example, imaging, over the wavelength range corresponding to the wavelengths used during the exposure of an object to be imaged.

The planar surfaces of microlenses 29 face pillars 33.

According to an embodiment, microlenses 29 are organized in the form of a grid of rows and of columns. Microlenses 29 are for example aligned. The repetition pattern of microlenses 29 is for example a square in which microlenses 29 are located at the four corners of the square.

According to another embodiment, microlenses 29 are organized in the form of a grid of rows and of columns in quincunx. In other words, the repetition pattern of microlenses 29 is for example a square in which microlenses 29 are located at the four corners and at the center of the square.

According to another embodiment, the arrangement of the microlenses and preferably the meshes of the angular filter are of generally hexagonal shape.

Call “h” the thickness or height (in the Z direction) of array 31. The height “h” of array 31 (and preferably of angular filter 23) is approximately constant, preferably constant.

Transparent pillars 33 may all substantially have the same dimensions. Call “w” the width (in the X direction in the case of a square mesh) of a pillar 33 (measured at the base of the pillar, that is, at the interface with substrate 30). The dimension in the orthogonal Y direction is preferably the same as in the X direction. In the case of a hexagonal mesh, width “w” corresponds to the dimension between the two opposite sides most distant two by two. Call “p” the repetition pitch of pillars 33, that is, the distance between centers of two successive pillars 33.

Pitch p may be in the range from 5 μm to 50 μm, for example equal to approximately 12 μm or approximately 18 μm. Height h may be in the range from 1 μm to 1 mm, preferably in the range from 5 μm to 30 μm, more preferably still in the range from 10 μm to 20 μm. Width w is preferably in the range from 0.5 μm, to 25 μm, for example approximately equal to 10 μm and more preferably still in the range from, 3 μm to 6 μm, for example, approximately 4 μm.

Each pillar 33 is preferably associated with a single microlens 29 of array 27. The optical axes of microlenses 29 are preferably aligned with the centers of the pillars 33 of array 31. The diameter of microlenses 29 is preferably greater than the maximum cross-section (measured perpendicularly to the optical axes) of pillars 33

The structure associating the array 27 of microlenses 29 and array 31 is adapted to filtering the incident radiation according to its wavelength and to the incidence of the radiation relative to the optical axes of the microlenses 29 or array 27. In other words, the structure is adapted to filtering incident rays, arriving onto the microlenses, according to their incidences and to their wavelengths. In the absence of a microlens, the radiation is less concentrated and focused by the filter which however plays its role of filtering the incident radiation relative to the axis of pillars 33.

The dimension in the XY plane of the openings of the filter or of the transparent pillars 33 is for example a function of the size of the pixels of the image acquisition device.

The described embodiments provide taking advantage of specific properties of the materials forming the array of transparent pillars 33 and of the walls 35 which separate them. More particularly, it is provided to select these materials, preferably organic resins, according to their respective refraction indexes to control the characteristics of the angular filter.

More precisely, different refraction indexes are provided for the pillars and for the walls. The materials forming pillars 33 and walls 35 are preferably solid materials, but in a simplified example of embodiment, air pillars 33 may be provided.

The selection of the materials according to their respective refraction indexes enables to control the angular transmission through the filter, which enables to optimize the selectivity of the filter in terms of incidence and of wavelength.

According to an aspect of the present disclosure, it is provided to select the material (the resin) forming pillars 33 so that its optical refraction index is greater than the refraction index of the material forming walls 35 or of the grid around the openings of the filter.

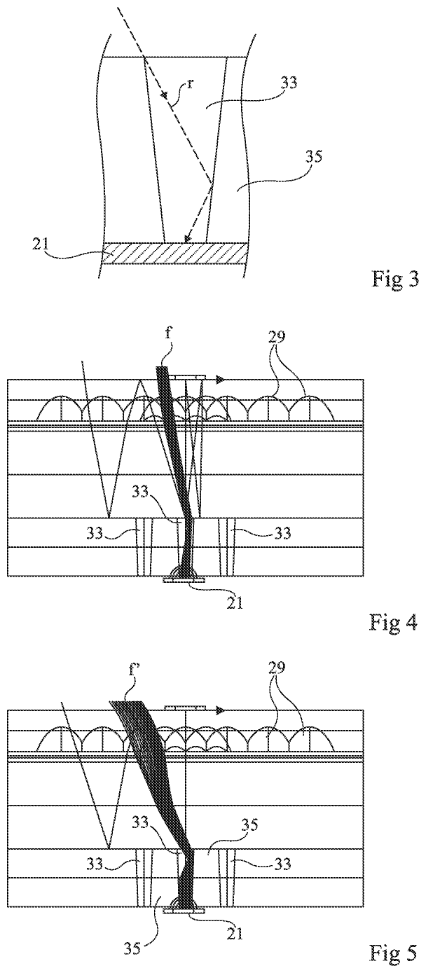

FIG. 3 illustrates in a simplified cross-section view the operation of an embodiment of an angular filter.

For simplification, only one pillar 33 is shown in FIG. 3. By properly selecting the refraction indexes of the organic resins forming walls 35 and pillars 33, it can be seen that an incident ray r undergoes a total inner reflection inside of the openings or pillars 33. This takes part in adjusting the angular transmission of filter 23 and provides an additional parameter with respect to the height and width of transparent pillars 33.

FIG. 4 illustrates in another simplified cross-section view the operation of an embodiment of an angular filter.

FIG. 5 illustrates in still another simplified cross-section view the operation of an embodiment of an angular filter.

FIGS. 4 and 5 are simplified representations illustrating the impact of the incidence of a beam of incident rays on the filter response.

In the example of FIG. 4, there is assumed a beam of rays of relatively small incidence, and, in the example of FIG. 5, a beam f′ of relatively high incidence (as compared with the small incidence of FIG. 4).

It can be observed that, for high incidence angles, part of the rays is guided into pillar 33 and thus transmitted by angular filter 23. This enables to widen the transmission peak with respect to an angular peak in which this reflection would not occur or would not be controlled by the selection of the refraction indexes of the respective materials of the transparent pillars and of the opaque walls.

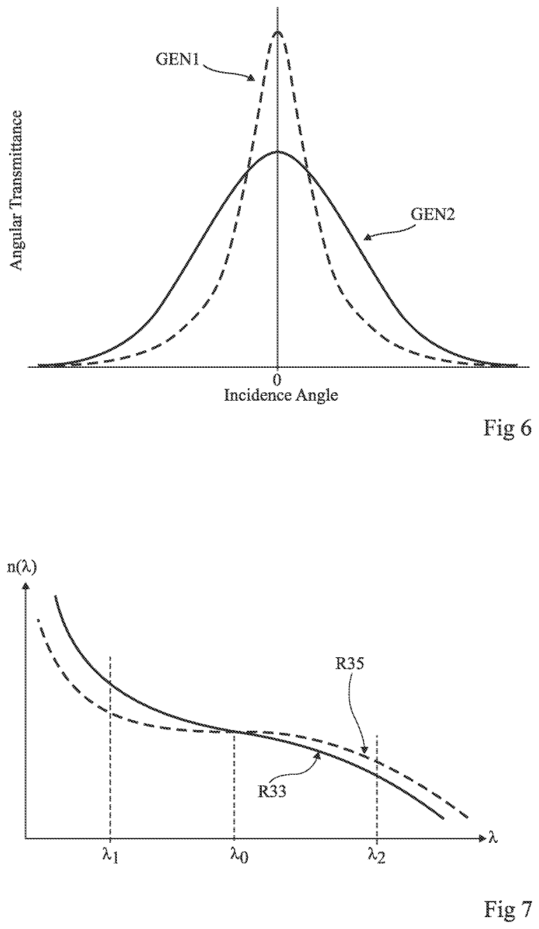

FIG. 6 shows examples of transmittance of angular filters.

Two curves GEN1 (in dotted lines) and GEN2 (in full line) of response of two different angular filters are illustrated in FIG. 6. The curves show the angular transmittance versus the incidence angle.

Response GEN1 symbolizes the response of a usual angular filter where the transmission of the angular filter according to the incidence is mainly conditioned by the dimensions (height and width or cross-section) of transparent pillars 33. The width of the transmission peak at half maximum (in degrees) of its transmittance is relatively narrow.

Response GEN2 symbolizes the response of an angular filter according to the described embodiments where, due to the refraction index variation between walls 35 and pillars 33, the effect linked to the dimensions of the pillars is combined with an effect of reflection inside thereof. The transmission peak is thus wider than in a usual filter.

Preferably, the thickness of angular filter 23 and more particularly of array or layer 31 is selected according to the selectivity desired for the angular filter.

According to another aspect of the present disclosure, it is provided to make the choice between the refraction indexes of walls 35 and of pillars 33 also according to the wavelength which is desired to be removed or favored in the response of the angular filter.

According to still another aspect of the present disclosure, a specific selection of the organic resins forming walls 35 and pillars 33 is provided so that the ratio between their respective refraction indexes is a function of the wavelength and, preferably, inverts for a given wavelength between a wavelength range to be transmitted and a wavelength range to be filtered.

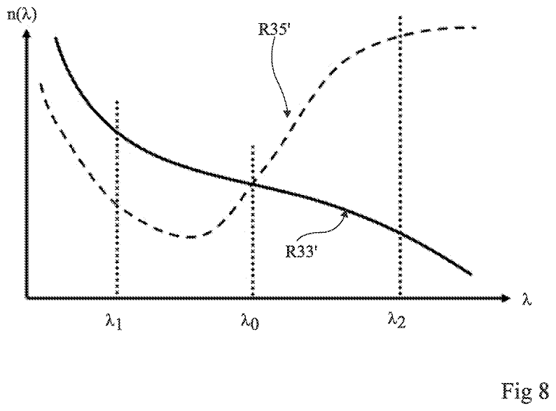

FIG. 7 illustrates the operation of an embodiment of an angular filter according to this aspect.

This drawing shows examples of curves R33 (curve in full line) and R35 (curve in dotted line) of variation of the refraction index “n” of a resin forming pillars 33 and of a resin forming walls 35 according to wavelength λ.

As can be seen in the drawing, curves R33 and R35 have generally similar shapes, refraction index n decreasing as the wavelength increases. However, the ratio between the respective indexes of the resins inverts for a wavelength λ0. This means that the ratio is smaller (or greater) than 1 for wavelengths smaller than λ0, equal to 1 for a wavelength equal to λ0, and greater (respectively lower) than 1 for wavelengths greater than λ0. More precisely, the ratio of the index of walls 35 to that of pillars 33 is smaller than 1 for wavelengths smaller than λ0 and greater than 1 for wavelengths greater than λ0.

In other words, the difference between the refraction indexes of the first and second materials changes sign at a given wavelength λ0 when the wavelength increases.

In the example of FIG. 7, the refraction index of the resin of walls 35 (curve in dotted line) is smaller than that of pillars 33 (curve in full line) for wavelengths smaller than λ0, while it is greater for wavelengths greater than λ0. Accordingly, for a wavelength λ1 (or a wavelength range) smaller than λ0, the rays are reflected inside of pillars 33 but are not, conversely, absorbed by walls 35. Conversely, for a wavelength λ2 (or a wavelength range) greater than λ0, the rays are not reflected inside of pillars 33.

One is then capable of conditioning the response of angular filter 23 and of optimizing its characteristics according to the wavelength range which is desired to be favored. This effect is obtained by a selection of the resins forming the walls and the pillars, each resin having a response in terms of refraction index according to its specific wavelength.

In other words, the materials are selected to have inverted refraction indexes at two different wavelengths λ1 and λ2.

Such an effect for example enables to integrate an infrared filter in the angular filter. Infrared rays (wavelengths smaller than λ0) are filtered while rays in the visible range are favored. The filter then operates as a color filter for wavelengths greater than λ0.

As a specific example of embodiment, the refraction index difference between the two materials is in the range from 0.001 to 0.5. According to a specific example of embodiment, the refraction index of the material forming walls 35 is, at wavelength λ1, in the range from 1.45 to 1.6. According to an embodiment, the refraction index of the material forming walls 35 is in the range from 1.52 to 1.57 and is, at wavelength λ1, in the order of 1.55, preferably 1.55. According to another embodiment, the refraction index of the material forming walls 35 is in the range from 1.45 to 1.5 and is, at wavelength λ1, in the order of 1.49, preferably of 1.49. According to a specific embodiment, the refraction index of the material forming pillars 33 is, at wavelength λ1, in the range from 1.55 to 1.65 and is, at wavelength λ1, in the order of 1.57, preferably 1.57.

Filter 23, more particularly the array of pillars 33, is formed by using thin film manufacturing technologies, which makes possible the integration of the filter in an imaging system while keeping a small distance of the scene to be imaged with the sensor.

FIG. 8 illustrates the operation of another preferred embodiment of an angular filter according to this aspect.

This drawing shows, like FIG. 7, examples of curves R33′ (curve in full line) and R35′ (curve in dotted line) of variation of the refraction index “n” of a resin forming pillars 33 and of a resin forming walls 35 according to wavelength λ.

As compared with the embodiment of FIG. 7, the general shapes of curves R33′ and R35′, while respecting the condition that the ratio between the respective indexes of the resins is a function of the wavelength and inverts for a wavelength λ0, have different general shapes. In particular, from wavelength λ0, the refraction index increases for walls 35 while it decreases for pillars 33. The ratio of the indexes (pillars/walls) is greater than 1 for wavelengths smaller than λ0, equal to 1 for a wavelength equal to λ0, and smaller than 1 for wavelengths greater than λ0.

Various embodiments and variants have been described. Those skilled in the art will understand that certain features of these various embodiments and variants may be combined, and other variants will occur to those skilled in the art.

Finally, the practical implementation of the described embodiments and variations is within the abilities of those skilled in the art based on the functional indications given hereabove.

1. An optical angular filter comprising:
an array of pillars made of a first transparent material;
an array of walls made of a second opaque material separating the pillars from one another, a ratio between refraction indexes of the first and second materials depending on a wavelength.

2. The optical angular filter according to claim 1, wherein a difference between the refraction indexes of the first and second materials changes sign at a given wavelength.

3. The optical angular filter according to claim 1, wherein the ratio between the refraction indexes of the first and second materials inverts for a given wavelength.

4. The optical angular filter according to claim 1, wherein the refraction index of the first material is, for wavelengths in the infrared range, greater than the refraction index of the second material and, for wavelengths in the a visible range, smaller than the refraction index of the second material.

5. The optical angular filter according to claim 1, wherein the refraction index of the second material is smaller than that of the first material, for at least a portion of a spectrum.

6. The optical angular filter according to claim 1, wherein the refraction index difference between two first and second materials is in the range from 0.001 to 0.5.

7-10. (canceled)

11. The optical angular filter according to claim 1, wherein a thickness of the filter is selected according to a selectivity desired for the optical angular filter.

12. The optical angular filter according to claim 1, wherein the first and second materials are organic resins.

13. The optical angular filter according to claim 1, further comprising an array of microlenses.

14. An image acquisition device comprising the optical angular filter according to claim 1.

15. The optical angular filter according to claim 2, wherein the refraction index of the first material is: in a range from 1.55 to 1.65; in the order of 1.57; or 1.57, at a wavelength smaller than said given wavelength.

16. The optical angular filter according to claim 3, wherein the refraction index of the first material is: in a range from 1.55 to 1.65; in the order of 1.57; or 1.57, at a wavelength smaller than said given wavelength.

17. The optical angular filter according to claim 2, wherein the refraction index of the second material is in a range from 1.45 to 1.6, at a wavelength smaller than said given wavelength.

18. The optical angular filter according to claim 3, wherein the refraction index of the second material is in a range from 1.45 to 1.6, at a wavelength smaller than said given wavelength.

19. The optical angular filter according to claim 2, wherein the refraction index of the second material is: in a range from 1.52 to 1.57; in the order of 1.55; or 1.55, and is at a wavelength smaller than said given wavelength.

20. The optical angular filter according to claim 3, wherein the refraction index of the second material is: in a range from 1.52 to 1.57; in the order of 1.55; or 1.55, and is at a wavelength smaller than said given wavelength.

21. The optical angular filter according to claim 2, wherein the refraction index of the second material is: in a range from 1.45 to 1.5; in the order of 1.49; or 1.49, and is at a wavelength smaller than said given wavelength.

22. The optical angular filter according to claim 3, wherein the refraction index of the second material is: in a range from 1.45 to 1.5; in the order of 1.49; or 1.49, and is at a wavelength smaller than said given wavelength.
